(19) United States
(12) Patent Application Publication
(10) Pub. No.: US 2024/0160467 A1
(43) Pub. Date: May 16, 2024

(54) INFORMATION PROCESSING SYSTEM, INFORMATION PROCESSING METHOD, PROGRAM, AND CLUSTER SYSTEM

(71) Applicant: SONY GROUP CORPORATION, TOKYO (JP)

(72) Inventors: TOMOYA FUJITA, TOKYO (JP); KENJI OGAWA, TOKYO (JP)

(21) Appl. No.: 18/548,830

(22) PCT Filed: Jan. 14, 2022
(86) PCT No.: PCT/JP2022/001120

§ 371 Date: Sep. 1, 2023

(30) Foreign Application Priority Data
Mar. 10, 2021 (JP) 2021-038080

(51) Int. Cl. G06F 9/46

(52) U.S. Cl. CPC G06F 9/465

(57) ABSTRACT

The present technology relates to an information processing system, an information processing method, a program, and a cluster system capable of improving stability of a cluster system. An information processing system operates in a moving body, is connected to other information processing system(s) via a network, and constitutes a cluster system with the other information processing system(s), and includes a management node determination unit that executes management node determination processing of determining a management node that manages the cluster system in cooperation with the other information processing system(s); a management node processing unit that executes processing of the management node in a case where the information processing system becomes the management node by the management node determination processing; and a worker node processing unit that executes processing of a worker node other than the management node in a case where the information processing system becomes the worker node by the management node determination processing. The present technology can be applied to, for example, a cluster system including a system operating in a vehicle.

### TECHNICAL FIELD

The present technology relates to an information processing system, an information processing method, a program, and a cluster system, in particular to an information processing system, an information processing method, a program, and a cluster system that improve stability of a cluster system.

### BACKGROUND ART

In recent years, a cluster system in which a plurality of systems cooperates to perform distributed processing has become widespread (see, for example, Patent Documents 1 and 2).

In the cluster system, a management node that manages the entire cluster system and performs a recovery process or the like when a failure occurs is provided.

### CITATION LIST

### Patent Document

Patent Document 1: Japanese Translation of PCT Application No. 2013-516665
Patent Document 2: Japanese Patent Application Laid-Open No. 2005-266939

### SUMMARY OF THE INVENTION

### Problems to be Solved by the Invention

However, when the management node leaves the cluster system due to a failure of the management node itself, a communication failure, or the like, the processing of the cluster system stops. Therefore, for example, in a case where a part of the cluster system operates on an edge device, the processing of the cluster system is likely to be stopped.

Here, the edge device is, for example, a terminal device connected to a network such as a vehicle, a robot, a drone, or an Internet of Things (IoT) device. The edge device is usually used by a user, and can be powered on/off. Furthermore, the edge device is not necessarily connected to the network by high-quality communication such as wired communication, and may be connected to the network by unstable wireless communication. Furthermore, some edge devices are physically movable devices such as a vehicle, and communication with the network may become unstable or be interrupted.

Therefore, for example, in a case where the management node exists on the cloud, when a communication failure occurs between the edge device and the cloud, the processing of the cluster system is stopped in the edge device. For example, in a case where the management node exists on the edge device, when the edge device is powered off, the processing of the cluster system is stopped.

The present technology has been made in view of such a situation, and is intended to improve stability of a cluster system

### Solutions to Problems

An information processing system according to a first aspect of the present technology operates in a moving body, is connected to other information processing system(s) via a network, and constitutes a cluster system with the other information processing system(s), and includes a management node determination unit that executes management node determination processing of determining a management node that manages the cluster system in cooperation with the other information processing system(s); a management node processing unit that executes processing of the management node in a case where the information processing system becomes the management node by the management node determination processing; and a worker node processing unit that executes processing of a worker node other than the management node in a case where the information processing system becomes the worker node by the management node determination processing.

An information processing method according to the first aspect of the present technology causes an information processing system that operates in a moving body, is connected to other information processing system(s) via a network, and constitutes a cluster system with the other information processing system(s) to execute management node determination processing of determining a management node that manages the cluster system in cooperation with the other information processing system(s); execute processing of the management node in a case where the information processing system becomes the management node by the management node determination processing; and execute processing of a worker node other than the management node in a case where the information processing system becomes the worker node by the management node determination processing.

A program according to the first aspect of the present technology causes a computer that operates in a moving body, is connected to other information processing system(s) via a network, and constitutes a cluster system with the other information processing system(s) to execute management node determination processing of determining a management node that manages the cluster system in cooperation with the other information processing system(s); execute processing of the management node in a case where the computer becomes the management node by the management node determination processing; and execute processing of a worker node other than the management node in a case where the computer becomes the worker node by the management node determination processing.

In the first aspect of the present technology, a management node that manages the cluster system is determined in cooperation with other information processing system(s), processing of the management node is executed in a case of becoming the management node, and processing of a worker node other than the management node is executed in a case of becoming the worker node.

A cluster system according to a second aspect of the present technology includes a plurality of information processing systems, and at least one of the information processing systems operates in a moving body, the plurality of the information processing systems executes management node determination processing of determining a management node that manages the cluster system in cooperation with one another, and an information processing system that has become the management node by the management node determination processing constructs the cluster system in which other information processing system(s) serve(s) as worker node(s).

In the second aspect of the present technology, at least one of the information processing systems operates in a moving body, the plurality of the information processing systems determines a management node that manages a cluster system in cooperation with one another, and an information processing system that has become the management node constructs the cluster system in which other information processing system(s) serve(s) as worker node(s).

### BRIEF DESCRIPTION OF DRAWINGS

FIG. 1 is a block diagram illustrating a configuration example of a vehicle control system.

FIG. 2 is a view illustrating an example of a sensing area.

FIG. 3 is a block diagram illustrating an embodiment of a cluster system to which the present technology is applied.

FIG. 4 is a flowchart for explaining processing of the entire cluster system.

FIG. 5 is a flowchart for explaining processing of a system constituting the cluster system.

FIG. 6 is a flowchart for explaining processing of a system constituting the cluster system.

FIG. 7 is a flowchart for explaining details of management node determination processing.

FIG. 8 is a block diagram illustrating a specific example of the cluster system to which the present technology is applied.

FIG. 9 is a sequence diagram illustrating a first specific example of processing of the cluster system.

FIG. 10 is a sequence diagram illustrating a second specific example of processing of the cluster system.

FIG. 11 is a sequence diagram illustrating a third specific example of processing of the cluster system.

FIG. 12 is a block diagram illustrating a specific example of an in-vehicle system.

FIG. 13 is a diagram illustrating a configuration example of a computer.

### MODE FOR CARRYING OUT THE INVENTION

Hereinafter, embodiments for carrying out the present technology will be described. Note that the description will be given in the following order.
1. Configuration Example of Vehicle Control System
2. Embodiment
3. Specific Example
4. Modifications
5. Others

### 1. Configuration Example of Vehicle Control System

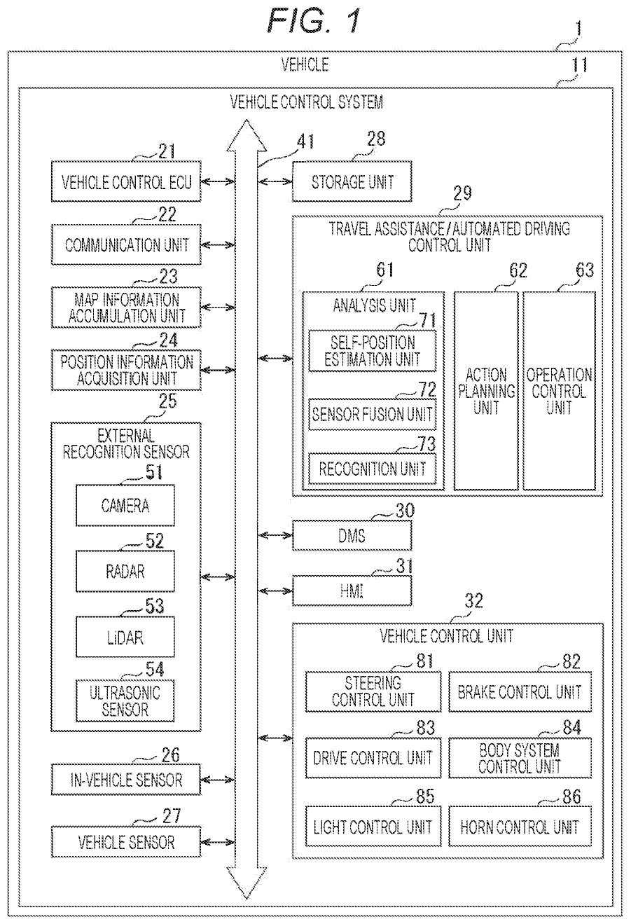

FIG. 1 is a block diagram illustrating a configuration example of a vehicle control system 11 that is an example of a mobile apparatus control system to which the present technology is applied.

The vehicle control system 11 is provided in a vehicle 1 and performs processing related to travel assistance and automated driving of the vehicle 1.

The vehicle control system 11 includes a vehicle control electronic control unit (ECU) 21, a communication unit 22, a map information accumulation unit 23, a position information acquisition unit 24, an external recognition sensor 25, an in-vehicle sensor 26, a vehicle sensor 27, a storage unit 28, a travel assistance/automated driving control unit 29, a driver monitoring system (DMS) 30, a human machine interface (HMI) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the travel assistance/automated driving control unit 29, the DMS 30, the HMI 31, and the vehicle control unit 32 are communicably connected to each other via a communication network 41. The communication network 41 is formed by, for example, an in-vehicle communication network, a bus, or the like that conforms to any digital bidirectional communication standard such as controller area network (CAN), local interconnect network (LIN), local area network (LAN), FlexRay (registered trademark), Ethernet (registered trademark), or the like. The communication network 41 may be selectively used depending on the type of data to be transmitted. For example, the CAN may be applied to data related to vehicle control, and the Ethernet may be applied to large-capacity data. Note that each unit of the vehicle control system 11 may be directly connected not via the communication network 41 but by, for example, wireless communication that assumes communication at a relatively short distance, such as near field communication (NFC) or Bluetooth (registered trademark).

Note that, hereinafter, in a case where each section of the vehicle control system 11 performs communication via the communication network 41, description of the communication network 41 will be omitted. For example, in a case where the vehicle control ECU 21 and the communication unit 22 perform communication via the communication network 41, it is simply described that the vehicle control ECU 21 and the communication unit 22 perform communication.

For example, the vehicle control ECU 21 is realized by a processor such as a central processing unit (CPU), a micro processing unit (MPU), and the like. The vehicle control ECU 21 controls the entire or partial function of the vehicle control system 11.

The communication unit 22 communicates with various devices inside and outside the vehicle, other vehicles, servers, base stations, and the like, and transmits and receives various data. At this time, the communication unit 22 can perform communication using a plurality of communication schemes.

Communication with the outside of the vehicle executable by the communication unit 22 will be schematically described. The communication unit 22 communicates with a server (hereinafter, the server is referred to as an external server) or the like existing on an external network via a base station or an access point by, for example, a wireless communication method such as fifth generation mobile communication system (5G), long term evolution (LTE), dedicated short range communications (DSRC), or the like. The external network with which the communication unit 22 performs communication is, for example, the Internet, a cloud network, a network unique to a company, or the like. A communication scheme performed by the communication unit 22 with respect to the external network is not particularly limited as long as it is a wireless communication scheme capable of performing digital bidirectional communication at a communication speed higher than or equal to a predetermined speed and at a distance longer than or equal to a predetermined distance.

Furthermore, for example, the communication unit 22 can communicate with a terminal existing in the vicinity of a host vehicle using a peer to peer (P2P) technology. A terminal present in the vicinity of the host vehicle is, for example, a terminal worn by a moving body moving at a relatively low speed such as a pedestrian or a bicycle, a terminal installed in a store or the like with a position fixed, or a machine type communication (MTC) terminal. Moreover, the communication unit 22 can also perform V2X communication. The V2X communication refers to, for example, communication between the host vehicle and another vehicle, such as vehicle to vehicle communication with another vehicle, vehicle to infrastructure communication with a roadside device or the like, vehicle to home communication, and vehicle to pedestrian communication with a terminal or the like possessed by a pedestrian.

For example, the communication unit 22 can receive a program for updating software for controlling the operation of the vehicle control system 11 from the outside (Over The Air). The communication unit 22 can further receive map information, traffic information, information around the vehicle 1, and the like from the outside. Furthermore, for example, the communication unit 22 can transmit information regarding the vehicle 1, information around the vehicle 1, and the like to the outside. Examples of the information regarding the vehicle 1 transmitted to the outside by the communication unit 22 include, for example, data indicating the state of the vehicle 1, a recognition result by a recognition unit 73, and the like. Moreover, for example, the communication unit 22 performs communication corresponding to a vehicle emergency call system such as an eCall.

For example, the communication unit 22 receives an electromagnetic wave transmitted by a road traffic information communication system (vehicle information and communication system (VICS), registered trademark), such as a radio wave beacon, an optical beacon, or FM multiplex broadcasting.

Communication with the inside of the vehicle executable by the communication unit 22 will be schematically described. The communication unit 22 can communicate with each device in the vehicle using, for example, wireless communication. The communication unit 22 can perform wireless communication with an in-vehicle device by a communication scheme capable of performing digital bidirectional communication at a predetermined communication speed or higher by wireless communication, such as wireless LAN, Bluetooth, NFC, or wireless USB (WUSB), for example. It is not limited thereto, and the communication unit 22 can also communicate with each device in the vehicle using wired communication. For example, the communication unit 22 can communicate with each device in the vehicle by wired communication via a cable connected to a connection terminal which is not illustrated. The communication unit 22 can communicate with each device in the vehicle by a communication scheme capable of performing digital bidirectional communication at a predetermined communication speed or higher by wired communication, such as universal serial bus (USB), high-definition multimedia interface (HDMI) (registered trademark), or mobile high-definition link (MHL).

Here, the device in the vehicle refers to, for example, a device that is not connected to the communication network 41 in the vehicle. As the device in the vehicle, for example, a mobile device or a wearable device carried by an occupant such as a driver or the like, an information device brought into the vehicle and temporarily installed, or the like is assumed.

The map information accumulation unit 23 accumulates one or both of a map acquired from the outside and a map created by the vehicle 1. For example, the map information accumulation unit 23 accumulates a three-dimensional high-precision map, a global map having lower accuracy than the high-precision map and covering a wide area, and the like.

The high-precision map is, for example, a dynamic map, a point cloud map, a vector map, or the like. The dynamic map is, for example, a map including four layers of dynamic information, semi-dynamic information, semi-static information, and static information, and is provided to the vehicle 1 from an external server or the like. The point cloud map is a map including point clouds (point cloud data). The vector map is, for example, a map in which traffic information such as a lane and a position of a traffic light is associated with a point cloud map and adapted to an advanced driver assistance system (ADAS) or autonomous driving (AD).

The point cloud map and the vector map may be provided from, for example, an external server or the like, or may be created by the vehicle 1 as a map for performing matching with a local map to be described later on the basis of a sensing result by a camera 51, a radar 52, a LiDAR 53, or the like, and may be accumulated in the map information accumulation unit 23. Furthermore, in a case where a high-precision map is provided from an external server or the like, for example, map data of several hundred meters square regarding a planned route on which the vehicle 1 travels from now is acquired from the external server or the like in order to reduce the communication capacity.

The position information acquisition unit 24 receives a global navigation satellite system (GNSS) signal from a GNSS satellite, and acquires position information of the vehicle 1. The acquired position information is supplied to the travel assistance/automated driving control unit 29. Note that the position information acquisition unit 24 is not limited to a method using the GNSS signal, and may acquire the position information using, for example, a beacon.

The external recognition sensor 25 includes various sensors used for recognizing an external situation of the vehicle 1, and supplies sensor data from each sensor to each part of the vehicle control system 11. The type and number of sensors included in the external recognition sensor 25 are arbitrary.

For example, the external recognition sensor 25 includes a camera 51, a radar 52, a light detection and ranging or laser imaging detection and ranging (LiDAR) 53, and an ultrasonic sensor 54. It is not limited thereto, and the external recognition sensor 25 may include one or more types of sensors among the camera 51, the radar 52, the LiDAR 53, and the ultrasonic sensor 54. The numbers of the cameras 51, the radars 52, the LiDAR 53, and the ultrasonic sensors 54 are not particularly limited as long as they can be practically installed in the vehicle 1. Furthermore, the type of sensor included in the external recognition sensor 25 is not limited to this example, and the external recognition sensor 25 may include another type of sensor. An example of the sensing area of each sensor included in the external recognition sensor 25 will be described later.

Note that an imaging method of the camera 51 is not particularly limited. For example, cameras of various imaging methods such as a time-of-flight (ToF) camera, a stereo camera, a monocular camera, and an infrared camera, which are imaging methods capable of distance measurement, can be applied to the camera 51 as necessary. It is not limited thereto, and the camera 51 may simply acquire a captured image regardless of distance measurement.

Furthermore, for example, the external recognition sensor 25 can include an environment sensor for detecting the environment for the vehicle 1. The environment sensor is a sensor for detecting an environment such as weather, climate, and brightness, and can include various sensors such as a raindrop sensor, a fog sensor, a sunshine sensor, a snow sensor, and an illuminance sensor, for example.

Moreover, for example, the external recognition sensor 25 includes a microphone used for detecting a sound around the vehicle 1, a position of a sound source, and the like.

The in-vehicle sensor 26 includes various sensors for detecting information inside the vehicle, and supplies sensor data from each sensor to each section of the vehicle control system 11. The type and number of various sensors included in the in-vehicle sensor 26 are not particularly limited as long as they are types and numbers that can be practically installed in the vehicle 1.

For example, the in-vehicle sensor 26 can include one or more sensors of a camera, a radar, a seating sensor, a steering wheel sensor, a microphone, and a biological sensor. As the camera included in the in-vehicle sensor 26, for example, cameras of various imaging methods capable of measuring a distance, such as a ToF camera, a stereo camera, a monocular camera, and an infrared camera, can be used. It is not limited thereto, and the camera included in the in-vehicle sensor 26 may simply acquire a captured image regardless of distance measurement. The biological sensor included in the in-vehicle sensor 26 is provided, for example, on a seat, a steering wheel, or the like, and detects various types of biological information of an occupant such as a driver.

The vehicle sensor 27 includes various sensors for detecting the state of the vehicle 1, and supplies sensor data from each sensor to each part of the vehicle control system 11. The type and number of various sensors included in the vehicle sensor 27 are not particularly limited as long as they are types and numbers that can be practically installed in the vehicle 1.

For example, the vehicle sensor 27 includes a speed sensor, an acceleration sensor, an angular velocity sensor (gyro sensor), and an inertial measurement unit (IMU) integrating these sensors. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the number of rotations of the engine or the motor, an air pressure sensor that detects the air pressure of the tire, a slip rate sensor that detects the slip rate of the tire, and a wheel speed sensor that detects the rotation speed of the wheel. For example, the vehicle sensor 27 includes a battery sensor that detects a remaining amount and a temperature of a battery, and an impact sensor that detects an external impact.

The storage unit 28 includes at least one of a nonvolatile storage medium or a volatile storage medium, and stores data and a program. The storage unit 28 is used as, for example, an electrically erasable programmable read only memory (EEPROM) and a random access memory (RAM), and a magnetic storage device such as a hard disc drive (HDD), a semiconductor storage device, an optical storage device, and a magneto-optical storage device can be applied as a storage medium. The storage unit 28 stores various programs and data used by each unit of the vehicle control system 11. For example, the storage unit 28 includes an event data recorder (EDR) and a data storage system for automated driving (DSSAD), and stores information of the vehicle 1 before and after an event such as an accident and information acquired by the in-vehicle sensor 26.

The travel assistance/automated driving control unit 29 controls travel assistance and automated driving of the vehicle 1. For example, the travel assistance/automated driving control unit 29 includes an analysis unit 61, an action planning unit 62, and an operation control unit 63.

The analysis unit 61 performs analysis processing of a situation of the vehicle 1 and the surroundings. The analysis unit 61 includes a self-position estimation unit 71, a sensor fusion unit 72, and the recognition unit 73.

The self-position estimation unit 71 estimates a self-position of the vehicle 1 on the basis of sensor data from the external recognition sensor 25 and a high-precision map accumulated in the map information accumulation unit 23. For example, the self-position estimation unit 71 generates a local map on the basis of sensor data from the external recognition sensor 25, and estimates the self-position of the vehicle 1 by matching the local map with the high-precision map. The position of the vehicle 1 is based on, for example, the center of a rear wheel-to-axle.

The local map is, for example, a three-dimensional high-precision map created using a technology such as simultaneous localization and mapping (SLAM), or the like, an occupancy grid map, or the like. The three-dimensional high-precision map is, for example, the above-described point cloud map or the like. The occupancy grid map is a map in which a three-dimensional or two-dimensional space around the vehicle 1 is divided into grids of a predetermined size, and an occupancy state of an object is indicated in units of grids. The occupancy state of the object is indicated by, for example, the presence or absence or existence probability of the object. The local map is also used for detection processing and recognition processing of a situation outside the vehicle 1 by the recognition unit 73, for example.

Note that the self-position estimation unit 71 may estimate the self-position of the vehicle 1 on the basis of the position information acquired by the position information acquisition unit 24 and the sensor data from the vehicle sensor 27.

The sensor fusion unit 72 performs sensor fusion processing to obtain new information by combining a plurality of different types of sensor data (for example, image data supplied from the camera 51 and sensor data supplied from the radar 52). Methods for combining different types of sensor data include integration, fusion, association, and the like.

The recognition unit 73 executes detection processing for detecting a situation outside the vehicle 1 and recognition processing for recognizing a situation outside the vehicle 1.

For example, the recognition unit 73 performs detection processing and recognition processing of the external situation of the vehicle 1 on the basis of information from the external recognition sensor 25, information from the self-position estimation unit 71, information from the sensor fusion unit 72, and the like.

Specifically, for example, the recognition unit 73 performs detection processing, recognition processing, and the like of an object around the vehicle 1. The object detection processing is, for example, processing of detecting the presence or absence, size, shape, position, movement, and the like of an object. The object recognition processing is, for example, processing of recognizing an attribute such as a type of an object or the like or identifying a specific object. However, the detection processing and the recognition processing are not always clearly separated and may overlap.

For example, the recognition unit 73 detects an object around the vehicle 1 by performing clustering to classify point clouds based on sensor data by the radar 52, the LiDAR 53, or the like into clusters of point clouds. Thus, the presence or absence, size, shape, and position of an object around the vehicle 1 are detected.

For example, the recognition unit 73 detects a motion of the object around the vehicle 1 by performing tracking that follows a motion of the cluster of point clouds classified by clustering. As a result, the speed and the traveling direction (movement vector) of the object around the vehicle 1 are detected.

For example, the recognition unit 73 detects or recognizes a vehicle, a person, a bicycle, an obstacle, a structure, a road, a traffic light, a traffic sign, a road sign, and the like on the basis of the image data supplied from the camera 51. Furthermore, the recognition unit 73 may recognize the type of the object around the vehicle 1 by performing recognition processing such as semantic segmentation.

For example, the recognition unit 73 can perform recognition processing of traffic rules around the vehicle 1 on the basis of a map accumulated in the map information accumulation unit 23, an estimation result of the self-position by the self-position estimation unit 71, and a recognition result of an object around the vehicle 1 by the recognition unit 73. Through this processing, the recognition unit 73 can recognize the position and the state of the traffic light, the contents of the traffic sign and the road sign, the contents of the traffic regulation, the travelable lane, and the like.

For example, the recognition unit 73 can perform recognition processing of the environment around the vehicle 1. As the surrounding environment to be recognized by the recognition unit 73, weather, temperature, humidity, brightness, a state of a road surface, and the like are assumed.

The action planning unit 62 creates an action plan for the vehicle 1. For example, the action planning unit 62 creates an action plan by performing route planning and route tracking processing.

Note that the route planning (Global path planning) is a process of planning a rough route from a start to a goal. This route planning is called a trajectory plan, and includes processing of performing a local path planning that enables safe and smooth traveling in the vicinity of the vehicle 1 in consideration of the motion characteristics of the vehicle 1 in the planned route.

Route following is processing of planning an operation for safely and accurately traveling a route planned by the route planning within a planned time. For example, the action planning unit 62 can calculate the target speed and the target angular velocity of the vehicle 1 based on a result of the route following processing.

The operation control unit 63 controls operation of the vehicle 1 in order to achieve the action plan created by the action planning unit 62.

For example, the operation control unit 63 controls a steering control unit 81, a brake control unit 82, and a drive control unit 83 included in the vehicle control unit 32 to be described later, and performs acceleration and deceleration control and direction control so that the vehicle 1 travels on the trajectory calculated by the trajectory planning. For example, the operation control unit 63 performs cooperative control for the purpose of implementing the functions of the ADAS such as collision avoidance or impact mitigation, follow-up traveling, vehicle speed maintaining traveling, collision warning of the host vehicle, lane deviation warning of the host vehicle, and the like. For example, the operation control unit 63 performs cooperative control for the purpose of automated driving or the like in which the vehicle autonomously travels without depending on the operation of the driver.

The DMS 30 performs authentication processing of a driver, recognition processing of a state of the driver, and the like on the basis of sensor data from the in-vehicle sensor 26, input data input to the HMI 31 to be described later, and the like. As the state of the driver to be recognized, for example, a physical condition, a wakefulness level, a concentration level, a fatigue level, a line-of-sight direction, a drunkenness level, a driving operation, a posture, and the like are assumed.

Note that the DMS 30 may perform authentication processing of an occupant other than the driver and recognition processing of a state of the occupant. Furthermore, for example, the DMS 30 may perform recognition processing of the situation inside the vehicle on the basis of sensor data from the in-vehicle sensor 26. As the condition inside the vehicle to be recognized, for example, temperature, humidity, brightness, odor, and the like are assumed.

The HMI 31 inputs various data, instructions, and the like, and presents various data to the driver and the like.

The input of data through the HMI 31 will be schematically described. The HMI 31 includes an input device for a person to input data. The HMI 31 generates an input signal on the basis of data, an instruction, or the like input with an input device, and supplies the input signal to each unit of the vehicle control system 11. The HMI 31 includes, for example, an operator such as a touch panel, a button, a switch, and a lever as the input device. The present technology is not limited thereto, and the HMI 31 may further include an input device capable of inputting information by a method other than manual operation by voice, gesture, or the like. Moreover, the HMI 31 may use, for example, a remote control device using infrared rays or radio waves, or an external connection device such as a mobile device or a wearable device corresponding to the operation of the vehicle control system 11 as an input device.

Presentation of data by the HMI 31 will be schematically described. The HMI 31 generates visual information, auditory information, and tactile information for the occupant or the outside of the vehicle. Furthermore, the HMI 31 performs output control for controlling an output, output contents, an output timing, an output method, and the like of each piece of generated information. The HMI 31 generates and outputs, for example, an operation screen, a state display of the vehicle 1, a warning display, an image such as a monitor image indicating a situation around the vehicle 1, and information indicated by light as the visual information. Furthermore, the HMI 31 generates and outputs information indicated by sounds such as voice guidance, a warning sound, and a warning message, for example, as the auditory information. Moreover, the HMI 31 generates and outputs, as the tactile information, information given to the tactile sense of the occupant by, for example, force, vibration, motion, or the like.

As an output device that the HMI 31 outputs visual information, for example, a display device that presents visual information by displaying an image by itself or a projector device that presents visual information by projecting an image can be applied. Note that the display device may be a device that displays visual information in the field of view of the occupant, such as a head-up display, a transmissive display, or a wearable device having an augmented reality (AR) function, for example, in addition to a display device having a normal display. Furthermore, in the HMI 31, a display device included in a navigation device, an instrument panel, a camera monitoring system (CMS), an electronic mirror, a lamp, or the like provided in the vehicle 1 can also be used as an output device that outputs visual information.

As the output device from which the HMI 31 outputs the auditory information, for example, an audio speaker, a headphone, or an earphone can be applied.

As an output device to which the HMI 31 outputs tactile information, for example, a haptic element using a haptic technology can be applied. The haptics element is provided, for example, at a portion with which an occupant of the vehicle 1 comes into contact, such as a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of a steering system of the vehicle 1. The steering system includes, for example, a steering mechanism including a steering wheel and the like, an electric power steering, and the like. The steering control unit 81 includes, for example, a steering ECU that controls a steering system, an actuator that drives the steering system, and the like.

The brake control unit 82 performs detection, control, and the like of a state of a brake system of the vehicle 1. The brake system includes, for example, a brake mechanism including a brake pedal, an antilock brake system (ABS), a regenerative brake mechanism, and the like. The brake control unit 82 includes, for example, a brake ECU that controls the brake system, an actuator that drives the brake system, and the like.

The drive control unit 83 performs detection, control, and the like of a state of a drive system of the vehicle 1. The drive system includes, for example, a driving force generation device for generating a driving force such as an accelerator pedal, an internal combustion engine, a driving motor, or the like, a driving force transmission mechanism for transmitting the driving force to wheels, and the like. The drive control unit 83 includes, for example, a drive ECU that controls the drive system, an actuator that drives the drive system, and the like.

The body system control unit 84 performs detection and control of a state of a body system of the vehicle 1, and the like. The body system includes, for example, a keyless entry system, a smart key system, a power window device, a power seat, an air conditioner, an airbag, a seat belt, a shift lever, and the like. The body system control unit 84 includes, for example, a body system ECU that controls the body system, an actuator that drives the body system, and the like.

The light control unit 85 performs detection and control of states of various lights of the vehicle 1, and the like. As the light to be controlled, for example, a headlight, a backlight, a fog light, a turn signal, a brake light, a projection, a display of a bumper, and the like are assumed. The light control unit 85 includes a light ECU that controls the lights, an actuator that drives the lights, and the like.

The horn control unit 86 performs detection and control of a state of a car horn of the vehicle 1, and the like. The horn control unit 86 includes, for example, a horn ECU that controls the car horn, an actuator that drives the car horn, and the like.

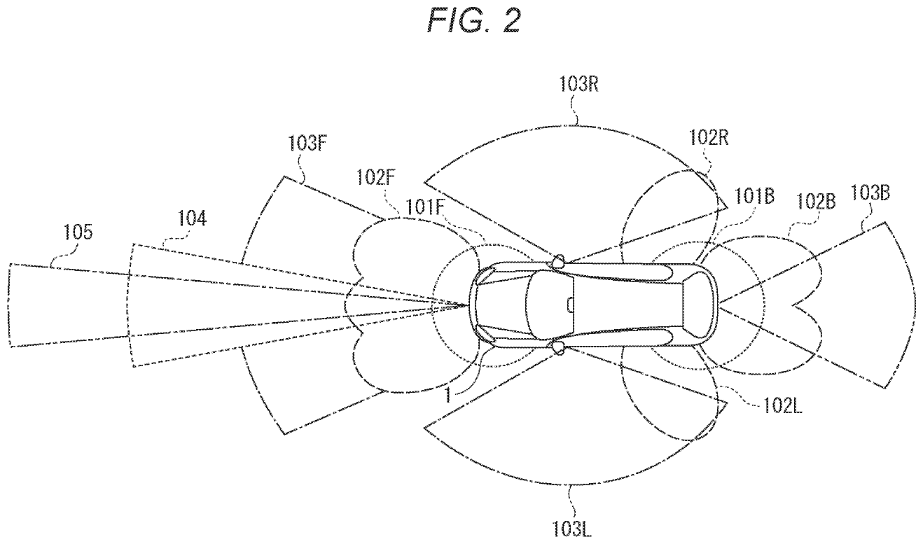

FIG. 2 is a diagram illustrating an example of a sensing area by the camera 51, the radar 52, the LiDAR 53, the ultrasonic sensor 54, and the like of the external recognition sensor 25 in FIG. 1. Note that FIG. 2 schematically illustrates the vehicle 1 as viewed from above, where a left end side is the front end (front) side of the vehicle 1 and a right end side is the rear end (rear) side of the vehicle 1.

The sensing area 101F and the sensing area 101B illustrate examples of sensing areas of the ultrasonic sensor 54. The sensing area 101F covers the periphery of the front end of the vehicle 1 by a plurality of the ultrasonic sensors 54. The sensing area 101B covers the periphery of the rear end of the vehicle 1 by the plurality of ultrasonic sensors 54.

Sensing results in the sensing area 101F and the sensing area 101B are used, for example, for parking assistance and the like of the vehicle 1.

The sensing areas 102F to 102B illustrate examples of sensing areas of the radar 52 for a short distance or a middle distance. The sensing area 102F covers a position farther than the sensing area 101F in front of the vehicle 1. The sensing area 102B covers a position farther than the sensing area 101B behind the vehicle 1. A sensing area 102L covers the rear periphery of the left side surface of the vehicle 1. The sensing area 102R covers the rear periphery of the right side surface of the vehicle 1.

The sensing result in the sensing area 102F is used, for example, to detect a vehicle, a pedestrian, or the like present in front of the vehicle 1. A sensing result in the sensing area 102B is used, for example, for a collision prevention function or the like behind the vehicle 1. Sensing results in the sensing areas 102L and 102R are used, for example, for detection of an object in a blind spot on a side of the vehicle 1, and the like.

Sensing areas 103F to 103B illustrate examples of sensing areas by the camera 51. The sensing area 103F covers a position farther than the sensing area 102F in front of the vehicle 1. The sensing area 103B covers a position farther than the sensing area 102B behind the vehicle 1. A sensing area 103L covers the periphery of the left side surface of the vehicle 1. A sensing area 103R covers the periphery of the right side surface of the vehicle 1.

A sensing result in the sensing area 103F can be used for, for example, recognition of a traffic light or a traffic sign, a lane departure prevention assist system, and an automatic headlight control system. A sensing result in the sensing area 103B is used for, for example, parking assistance, a surround view system, and the like. Sensing results in the sensing area 103L and the sensing area 103R can be used for a surround view system, for example.

A sensing area 104 illustrates an example of a sensing area by the LiDAR 53. The sensing area 104 covers a position farther than the sensing area 103F in front of the vehicle 1. Meanwhile, the sensing area 104 has a narrower range in a left-right direction than the sensing area 103F.

A sensing result in the sensing area 104 is used, for example, for detecting an object such as a surrounding vehicle.

The sensing area 105 illustrates an example of a sensing area of the long-range radar 52. The sensing area 105 covers a position farther than the sensing area 104 in front of the vehicle 1. Meanwhile, the sensing area 105 has a narrower range in the left-right direction than the sensing area 104.

The sensing result in the sensing area 105 is used for, for example, adaptive cruise control (ACC), emergency braking, collision avoidance, and the like.

Note that the sensing areas of the respective sensors of the camera 51, the radar 52, the LiDAR 53, and the ultrasonic sensor 54 included in the external recognition sensor 25 may have various configurations other than those in FIG. 2. Specifically, the ultrasonic sensor 54 may also sense the side of the vehicle 1, or the LiDAR 53 may sense the rear of the vehicle 1. Furthermore, the installation position of each sensor is not limited to each example described above. Furthermore, the number of sensors may be one or more.

The present technology relates to a cluster system in which at least a part operates on an edge device such as the vehicle 1 (the vehicle control system 11).

### 2. Embodiment

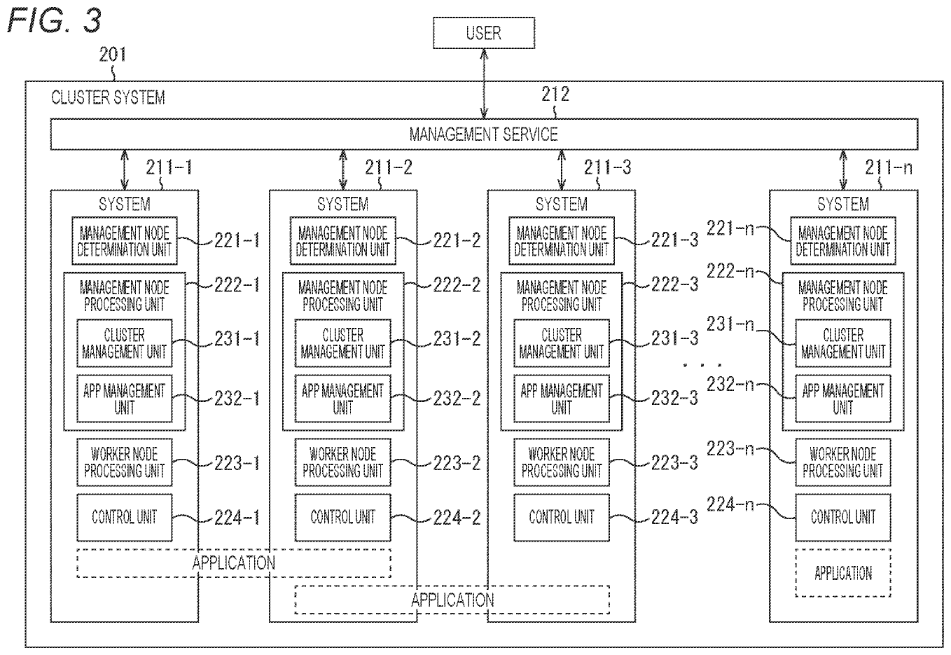

Next, an embodiment of the present technology will be described with reference to FIGS. 3 to 7.

<Configuration Example of Cluster System>

FIG. 3 is a block diagram illustrating a configuration example of a cluster system 201 which is one embodiment of a cluster system to which the present technology is applied.

The cluster system 201 includes systems 211-1 to 211-n. The systems 211-1 to 211-n are connected to each other via various networks (for example, the Internet) that is not illustrated, and can communicate with each other. In the cluster system 201, the systems 211-1 to 211-n cooperate to perform distributed processing, and operate as one system from the viewpoint of the user.

Note that, hereinafter, in a case where it is not necessary to individually distinguish the systems 211-1 to 211-n, they are simply referred to as the system 211. Furthermore, hereinafter, the cluster system may be simply referred to as a cluster. For example, the cluster system 201 may be simply referred to as a cluster 201.

Each system 211 is an information processing system realized by hardware or software. For example, in a case where the system 211 is realized by software, a plurality of systems 211 can operate on the same hardware.

Note that at least a part of the system 211 is realized by an edge device such as the vehicle 1 or operates on the edge device.

The number n of systems 211 can be set to any number of 1 or more. Furthermore, the configuration of the cluster system 201 can be dynamically changed. That is, it is possible to dynamically add or delete the system 211 of the cluster system 201.

The system 211-i (i=1 to n) includes a management node determination unit 221-i, a management node processing unit 222-i, a worker node processing unit 223-i, and a control unit 224-i. The management node processing unit 222-i includes a cluster management unit 231-i and an application (APP) management unit 232-i.

Note that, hereinafter, in a case where it is not necessary to individually distinguish the management node determination units 221-1 to 221-n, they are simply referred to as a management node determination unit 221. Hereinafter, in a case where it is not necessary to individually distinguish the management node processing units 222-1 to 222-n, they are simply referred to as a management node processing unit 222. Hereinafter, in a case where it is not necessary to individually distinguish the worker node processing units 223-1 to 223-n, they are simply referred to as a worker node processing unit 223. Hereinafter, in a case where it is not necessary to individually distinguish the control units 224-1 to 224-n, they are simply referred to as a control unit 224. Hereinafter, in a case where it is not necessary to individually distinguish the cluster management units 231-1 to 231-n, they are simply referred to as a cluster management unit 231. Hereinafter, in a case where it is not necessary to individually distinguish the application management units 232-1 to 232-n, they are simply referred to as an application management unit 232.

The management node determination unit 221 performs management node determination processing of determining one management node from among the systems 211 constituting the cluster system 201 in cooperation with the management node determination unit 221 of another system 211.

Here, each system 211 constitutes a node of the cluster system 201. One of the nodes of the cluster system 201 serves as a management node, and remaining nodes serve as worker nodes. The management node manages the cluster system 201 and manages an application executed in the cluster system 201.

In a case where the system 211 operates as a management node, the management node processing unit 222 performs various kinds of processing related to the cluster system 201. The management node processing unit 222 is realized, for example, execution of a management service 212, which is software serving as an interface with a user, by the system 211. As described above, the management node processing unit 222 includes the cluster management unit 231 and the application management unit 232.

The cluster management unit 231 manages the cluster system 201. Specifically, for example, the cluster management unit 231 performs construction, update, and the like of the cluster system 201. For example, the cluster management unit 231 monitors a state of each worker node.

The application management unit 232 manages an application executed in the cluster system 201. Specifically, for example, the application management unit 232 determines an application necessary for realizing the processing of the cluster system 201, and allocates an application to be executed to each worker node. Therefore, a role is allocated to each node. Furthermore, for example, the application management unit 232 controls processing of each worker node by instructing processing of an application executed by each worker node. For example, the application management unit 232 executes processing of an application allocated to itself, and transmits a processing result to the outside as necessary.

In a case where the system 211 operates as a worker node, the worker node processing unit 223 performs various kinds of processing related to the cluster system 201. For example, the worker node processing unit 223 requests registration in the cluster system 201 by communicating with the management node via a network. For example, the worker node processing unit 223 monitors a state of the management node. For example, the worker node processing unit 223 executes processing of the allocated application under instruction of the management node, and transmits a processing result to the outside as necessary.

The control unit 224 controls the entire system 211.

Note that each system 211 may execute an application independently or may execute an application in cooperation with another system 211. Although FIG. 3 illustrates an example in which two systems 211 cooperate to execute one application, three or more systems 211 may cooperate to execute one application. Furthermore, each system 211 can execute two or more types of applications.

Furthermore, hereinafter, in a case where each system 211 performs communication via a network, description of the “network” will be omitted.

<Flow of Processing of Entire Cluster System 201>

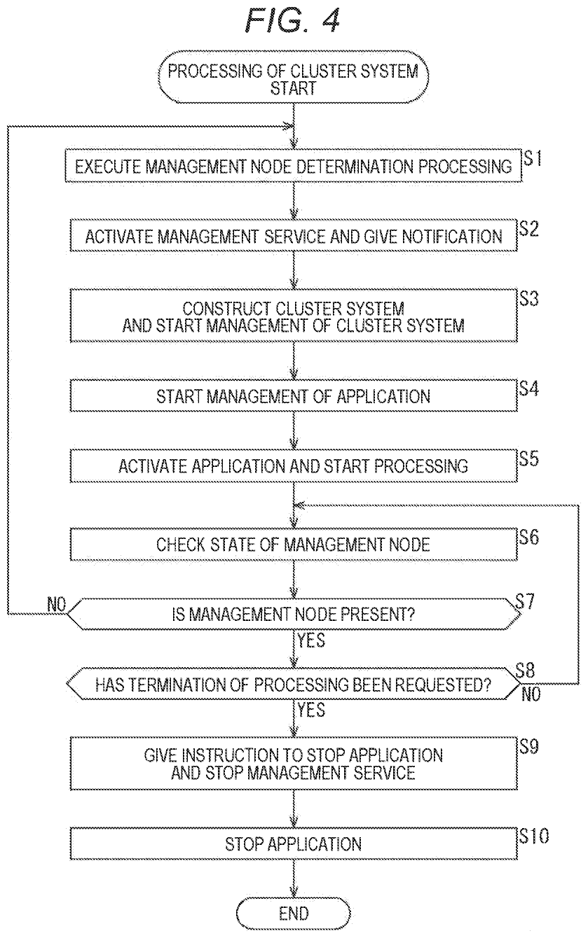

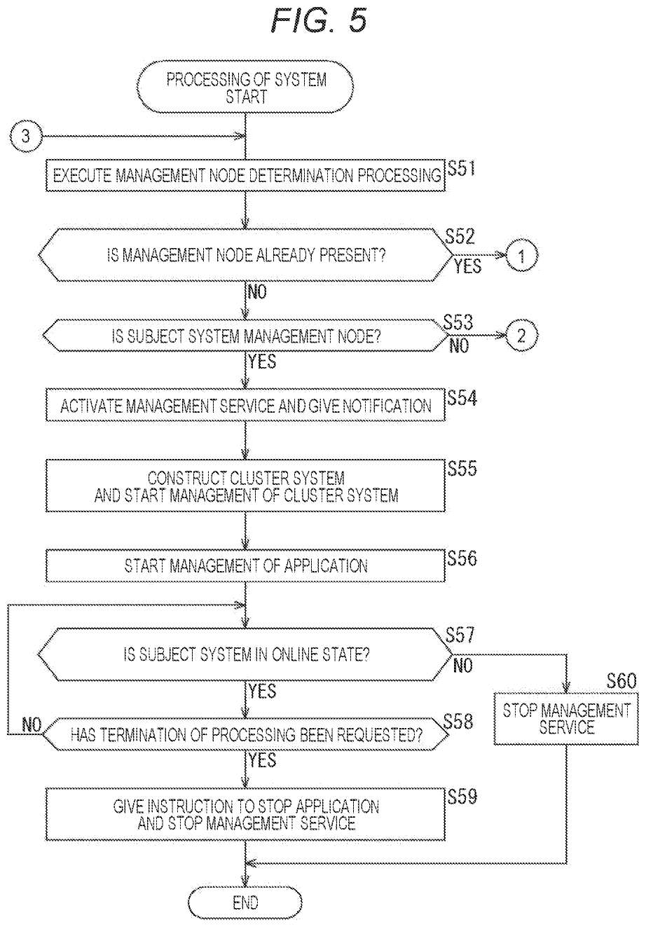

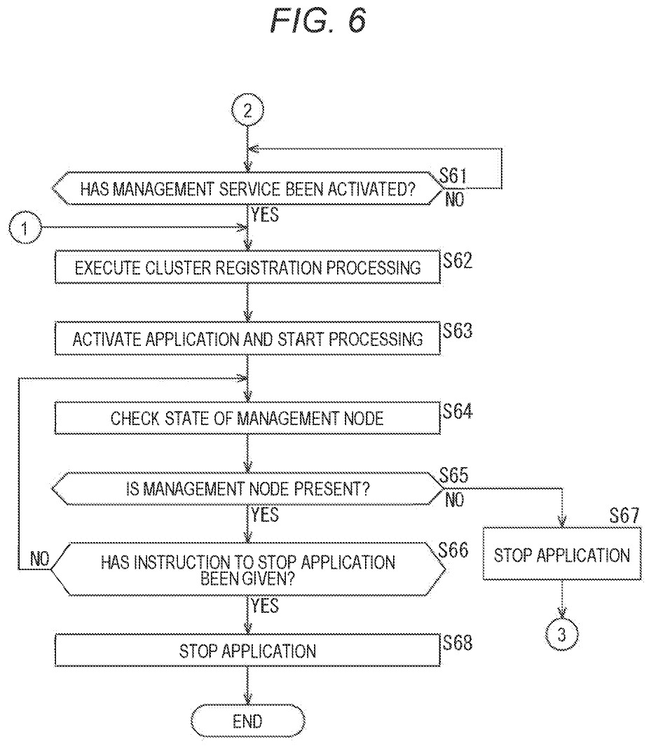

Next, a flow of processing of the entire cluster system 201 will be described with reference to a flowchart of FIG. 4. Note that details of the processing of each system 211 will be described later with reference to FIGS. 5 and 6.

This processing is started, for example, when the user performs an operation for requesting start of the processing and an operation signal is transmitted to each system 211.

In step S1, each system 211 executes management node determination processing. Although details of the management node determination processing will be described later, one management node is thus determined from among all the systems 211.

In step S2, the management node activates a management service and gives a notification. That is, the management node activates the management service and notifies the other systems 211 of the activation of the management service.

In step S3, the management node constructs the cluster system 201 and starts management of the cluster system 201.

Specifically, the system 211 other than the management node requests the management node to register the system 211 in the cluster system 201.

In response to this, the management node registers the system 211 that has requested registration in the cluster system 201 as a worker node. As a result, the cluster system 201 including the management node and the worker node is constructed. Furthermore, the management node starts update processing of the cluster system 201, monitors the state of the worker node, and performs addition, deletion, or the like of a worker node as necessary.

In step S4, the management node starts management of an application. For example, the management node determines an application necessary for realizing the processing of the cluster system 201. Furthermore, the management node allocates an application to be executed to each worker node, and notifies each worker node of the allocated application. At this time, a part of the application may be allocated to the management node itself. Furthermore, the management node starts processing of dynamically changing arrangement of applications in response to addition and deletion of a worker node. Moreover, the management node instructs processing of an application executed by each worker node and starts processing of controlling the processing of each worker node.

In step S5, each node activates an application and starts processing. Specifically, each worker node activates an application of which the worker node has been notified by the management node. Furthermore, each worker node starts processing of executing processing instructed by the management node. Furthermore, in a case where the management node itself executes an application, the management node activates the application and starts processing of the application.

In step S6, each worker node checks a state of the management node. For example, the management node regularly broadcasts a signal (hereinafter referred to as a heartbeat signal) that notifies each worker node of existence of the management node to each worker node.

Meanwhile, each worker node checks the state of the management node on the basis of the presence or absence of reception of the heartbeat signal from the management node.

In step S7, each worker node determines whether or not the management node is present. In a case where each worker node receives the heartbeat signal within a predetermined period from previous reception of the heartbeat signal from the management node, it is determined that the management node is present, and the processing proceeds to step S8.

In step S8, the management node determines whether or not termination of the processing has been requested. In a case where it is determined that termination of the processing is not requested, the processing returns to step S6.

Thereafter, the processes in steps S6 to S8 are repeatedly executed until it is determined in step S7 that the management node is not present or it is determined in step S8 that termination of the processing has been requested.

On the other hand, in a case where any of the worker nodes does not receive the heartbeat signal within a predetermined period from previous reception of the heartbeat signal from the management node, it is determined in step S7 that the management node is not present, and the processing returns to step S1.

Thereafter, the processes in step S1 and subsequent steps are executed. That is, since there is no management node, the management node determination processing is executed again, one management node is determined from among the worker nodes, and the cluster system 201 is reconstructed under the determined management node.

On the other hand, for example, in a case where the user performs an operation requesting termination of the processing and the management node receives the operation signal, the management node determines in step S8 that termination of the processing has been requested, and the processing proceeds to step S9.

In step S9, the management node gives an instruction to stop the application and stops the management service. Specifically, the management node instructs each worker node to stop the application. Furthermore, the management node stops the management service and notifies each worker node of the stop of the management service.

In step S10, each worker node stops the application.

Thereafter, the processing of the cluster system 201 ends.

<Processing of Each System 211>

Next, processing executed by each system 211 will be described with reference to FIGS. 5 and 6.

Note that, hereinafter, a system 211 for which the processing will be described by using this flowchart is referred to as a subject system, and systems 211 other than the subject system are referred to as other systems.

This processing is started, for example, when the subject system is connected to a network that connects the systems 211.

In step S51, the management node determination unit 221 executes management node determination processing. Although details of the management node determination processing will be described later, the management node determination unit 221 performs processing of determining a management node in cooperation with the other systems.

In step S52, the management node determination unit 221 determines whether or not a management node is already present on the basis of a result of the processing in step S51. In a case where the management node determination unit 221 determines that no management node is present before the management node determination processing, the processing proceeds to step S53.

In step S53, the management node determination unit 221 determines whether or not the subject system itself is a management node. In a case where the subject system becomes a management node as a result of the management node determination processing, the management node determination unit 221 determines that the subject system is a management node, and the processing proceeds to step S54.

In step S54, the system 211 activates the management service and gives a notification. Specifically, the management node determination unit 221 activates the management service. As a result, the management node processing unit 222 is activated. Next, the cluster management unit 231 notifies the other systems of the activation of the management service.

In step S55, the cluster management unit 231 constructs a cluster system and starts cluster management.

Specifically, the other systems that have received the notification of the activation of the management service request the management node to register the other systems in the cluster system 201.

Meanwhile, the cluster management unit 231 executes processing similar to that in step S3 in FIG. 4 described above.

In step S56, the application management unit 232 starts management of an application. That is, the application management unit 232 executes processing similar to that in step S4 in FIG. 4 described above.

In step S57, the cluster management unit 231 determines whether or not the subject system is in an online state. In a case where the subject system is connected to the network and can communicate with the worker nodes, the cluster management unit 231 determines that the subject system is in the online state, and the processing proceeds to step S58.

In step S58, the cluster management unit 231 executes processing similar to that in step S8 in FIG. 4 described above, and determines whether or not termination of the processing has been requested. In a case where it is determined that termination of the processing is not requested, the processing returns to step S57.

Thereafter, the processes in steps S57 and S58 are repeatedly executed until it is determined in step S57 that the subject system is not in the online state or it is determined in step S58 that termination of the processing has been requested.

On the other hand, in a case where it is determined in step S58 that termination of the processing has been requested, the processing proceeds to step S59.

In step S59, the system 211 gives an instruction to stop the application and terminates the management service. Specifically, the application management unit 232 instructs each worker node to stop the application. Furthermore, the cluster management unit 231 stops the management service. The management node determination unit 221 notifies each worker node of the stop of the management service.

In response to this, each worker node stops the application.

Thereafter, the processing of the system 211 ends.

On the other hand, in a case where it is determined in step S57 that the subject system is not in the online state, the processing proceeds to step S60.

In step S60, the cluster management unit 231 stops the management service.

Thereafter, the processing of the system 211 ends.

On the other hand, in a case where another system becomes a management node as a result of the management node determination processing, the management node determination unit 221 determines in step S53 that the subject system is not a management node, and the processing proceeds to step S61.

In step S61, the worker node processing unit 223 determines whether or not the management service has been activated. This processing is repeatedly executed until it is determined that the management service has been activated.

On the other hand, in a case where a notification of the activation of the management service is given from the management node, the worker node processing unit 223 determines in step S61 that the management service has been activated, and the processing proceeds to step S62.

Furthermore, in a case where it is determined in step S52 that the management node is already present, the processing proceeds to step S62.

In step S62, the worker node processing unit 223 executes cluster registration processing. Specifically, the worker node processing unit 223 requests the management node to register the subject system in the cluster system 201.

In response to this, the management node registers the system 211 in the cluster system 201 as a worker node.

In step S63, the worker node processing unit 223 executes processing similar to that in step S5 in FIG. 4 described above, and activates an application and starts the processing.

In step S64, the worker node processing unit 223 executes processing similar to that in step S6 in FIG. 4 described above, and checks a state of the management node.

In step S65, the worker node processing unit 223 determines whether or not the management node is present. In a case where the worker node processing unit 223 receives a heartbeat signal within a predetermined period from previous reception of a heartbeat signal from the management node and it is not determined by another worker node that the management node is not present, it is determined that the management node is present, and the processing proceeds to step S66.

In step S66, the worker node processing unit 223 determines whether or not an instruction to stop the application has been given. In a case where it is determined that an instruction to stop the application has not been given, the processing returns to step S64.

Thereafter, the processes in steps S64 to S66 are repeatedly executed until it is determined in step S65 that the management node is not present or it is determined in step S66 that an instruction to stop the application has been given.

On the other hand, in a case where the worker node processing unit 223 does not receive a heartbeat signal within a predetermined period from previous reception of a heartbeat signal from the management node or it is determined by another worker node that the management node is not present, it is determined in step S65 that the management node is not present, and the processing proceeds to step S67.

Note that, in a case where the worker node processing unit 223 has not received a heartbeat signal within the predetermined period from the previous reception of a heartbeat signal from the management node, the worker node processing unit 223 notifies the other worker nodes of absence of management node.

In step S67, the worker node processing unit 223 stops the application.

Thereafter, the processing returns to step S51, and the processing in and after step S51 is executed. That is, since there is no management node, the management node determination processing is executed again. Then, after the management node is determined, the cluster system 201 is reconstructed and the processing is continued.

On the other hand, in a case where the worker node processing unit 223 determines in step S66 that an instruction to stop the application has been given from the management node, the processing proceeds to step S68.

In step S68, the worker node processing unit 223 stops the application.

Thereafter, the processing of the system 211 ends.

<Management Node Determination Processing>

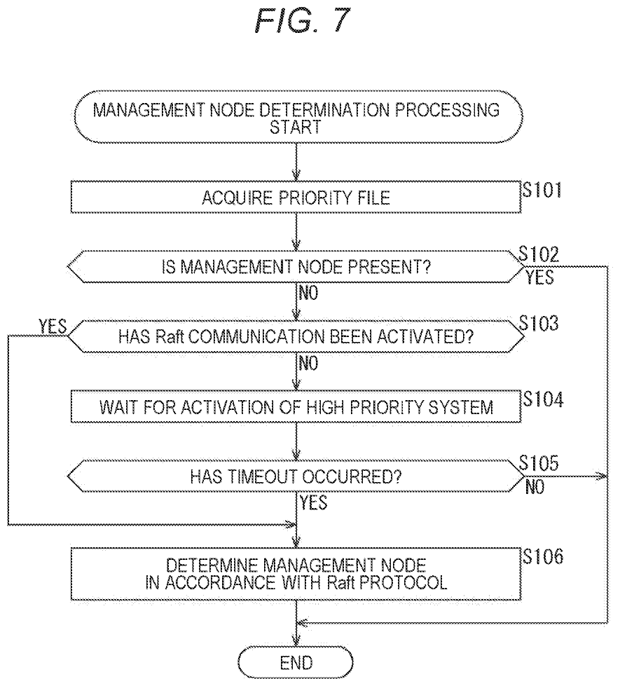

Next, details of the management node determination processing executed by each system 211 will be described with reference to the flowchart of FIG. 7.

Note that, in this example, processing in a case where the management node is determined by using the Raft protocol will be described.

In step S101, the management node determination unit 221 acquires a priority file. For example, the user inputs the priority file, and the management node determination unit 221 acquires the input priority file.

Here, the priority file is a file indicating a priority as to whether each system 211 becomes a management node. That is, a system 211 given a higher priority has a higher possibility of becoming a management node, and a system 211 given a lower priority has a lower possibility of becoming a management node.

For example, the user sets the priority of each system 211 in advance in consideration of one or more of capability, processing content, intended use, operation environment, and the like of each system 211. Here, as the user who sets the priority, for example, an administrator of the cluster system 201, an administrator who adds a specific system 211 to the cluster system 201, or the like is assumed.

For example, in a case where the capabilities of the systems 211 are equivalent, the systems 211 are set to the same priority. For example, a case where the systems 211 are robots having equivalent specifications is assumed as this case. In this case, for example, the management node is determined by first-win majority decision. Specifically, for example, a system 211 that satisfies a predetermined condition sequentially nominates itself as a candidate for the management node, and notifies the other systems 211 of the nomination as a candidate. Meanwhile, each system 211 votes for itself in a case where the system 211 nominates itself as a candidate, and in a case where a notification indicating that another system 211 has nominated itself as a candidate is given, each system 211 votes for a system 211 that has given the notification first. As a result, a system 211 that gets the largest number of votes becomes the management node.

On the other hand, in a case where there is a difference in capability among the systems 211, a system 211 having a higher capability is set to have a higher priority. For example, a system 211 having larger hardware resources such as a CPU and a memory is set to have a higher priority. On the other hand, a system 211 having smaller hardware resources such as a CPU and a memory is set to have a lower priority.

For example, in a case where each system 211 operates on cloud and the vehicle control system 11, a system 211 operating on cloud of high stability is set to have a high priority. On the other hand, a system 211 operating on the vehicle control system 11 of low stability is set to have a low priority.

For example, a system 211 that does not perform real-time processing is set to have a high priority. On the other hand, a system 211 that performs real-time processing is set to have a low priority. This is to prevent the real-time processing from being delayed due to processing of the management node because the real-time processing has high importance.

Note that, for example, a system 211 excluded from candidates for the management node may be registered in the priority file. Therefore, for example, a system 211 that performs real-time processing and a system 211 having low capability can be excluded from the candidates for the management node.

Furthermore, even a system 211 registered in the priority file as a candidate for the management node is excluded from the candidates for the management node in a case where the system 211 cannot communicate with another system 211, for example, due to power off, failure, or the like.

In step S102, the management node determination unit 221 determines whether or not the management node is present. For example, in a case where a heartbeat signal is not received within a predetermined period, the management node determination unit 221 determines that the management node is not present, and the processing proceeds to step S103.

In step S103, the management node determination unit 221 determines whether or not Raft communication (Raft consensus protocol communication) has been activated. In a case where it is determined that the Raft communication has not been activated, the processing proceeds to step S104.

In step S104, the management node determination unit 221 waits for activation of a high priority system. Specifically, the management node determination unit 221 waits for activation of another system having a higher priority than the subject system on the basis of the priority file.

In step S105, the management node determination unit 221 determines whether or not a timeout has occurred. In a case where it is determined that a timeout has occurred, that is, in a case where the high priority system has not been activated within a predetermined period although the management node determination unit 221 has waited for activation of the high priority system, the processing proceeds to step S106.

On the other hand, in a case where it is determined in step S103 that the Raft communication has been activated, the processing in steps S104 and S105 is skipped, and the processing proceeds to step S106.

In step S106, the management node determination unit 221 determines the management node in accordance with the Raft protocol. That is, the management node determination unit 221 determines the management node from among the candidates for the management node including the subject system in cooperation with the other systems in accordance with LeaderElection of the Raft protocol.

Thereafter, the management node determination processing ends.

On the other hand, in a case where it is determined in step S105 that a timeout has occurred, that is, in a case where the high priority system has been activated within the predetermined period, the processing in step S106 is skipped, and the management node determination processing ends. In this case, the subject system does not become a candidate for the management node, and the management node is determined from among the high-priority systems.

On the other hand, in a case where a heartbeat signal is received within the predetermined period, the management node determination unit 221 determines in step S102 that the management node is present, the processing in steps S103 to S106 is skipped, and the management node determination processing ends.

In this way, flexibility of the cluster system 201 is improved, and as a result, stability of the cluster system 201 is improved.

Specifically, in a case where the management node leaves the cluster system 201, the management node is automatically selected and the cluster system 201 is reconstructed without user intervention. Therefore, the cluster system 201 can continue the processing.

Furthermore, a system 211 including a device whose operation or communication may become unstable such as an edge device or a system 211 operating on the device can be added to the cluster system 301 and further can be used as a management node.

Moreover, an appropriate management node can be selected according to a situation on the basis of a priority. For example, except during occurrence of a failure, a system that operates stably can be selected as the management node. Furthermore, even during occurrence of a failure, a system having sufficient capability can be selected as the management node.

### 3. Specific Example

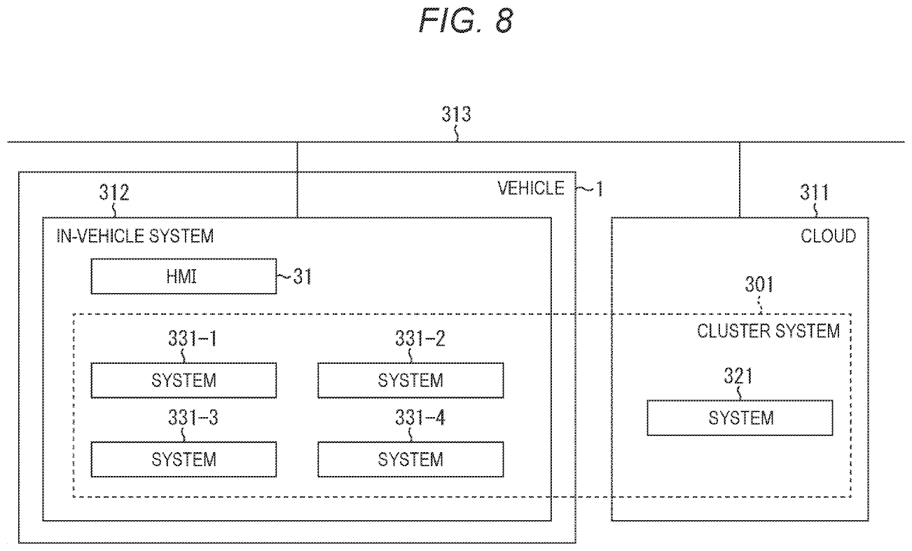

Next, a specific example of a case where the present technology is applied to the vehicle 1 (the vehicle control system 11) will be described with reference to FIGS. 8 to 12.

<Specific Example of Cluster System>

FIG. 8 illustrates a configuration example of a cluster system 301 which is a specific example of the cluster system 201 described above. Note that portions corresponding to those in FIG. 1 are denoted by the same reference numerals, and the description thereof will be omitted as appropriate.

The cluster system 301 includes a system 321 and systems 331-1 to 331-4. The system 321 is a system existing on cloud 311. The systems 331-1 to 331-4 are systems existing on an in-vehicle system 312.

The cloud 311 and the in-vehicle system 312 are connected via a network 313 such as the Internet.

The cloud 311 includes a server and the like, and operates stably.

As the system 321 of the cloud 311, for example, an operating system instance existing on a cloud infrastructure is assumed. For example, as the system 321 of the cloud 311, an instance, a serverless service, or the like that exists on a cloud service and is accessible via the Internet is assumed.

A priority of the system 321 is set higher than those of the systems 331-1 to 331-4 of the in-vehicle system 312. Furthermore, the system 321 executes an application that does not perform output to a user as necessary.

The in-vehicle system 312 constitutes a part of the vehicle control system 11 of the vehicle 1 of FIG. 1. The in-vehicle system 312 includes an HMI 31 and the systems 331-1 to 331-4.

The systems 331-1 to 331-4 are realized by, for example, the vehicle control ECU 21 of FIG. 1. Specifically, for example, the systems 331-1 to 331-4 include a system existing on a physical chip or a system instance created by virtualization. The systems 331-1 to 331-4 are connected to each other via a network (not illustrated).

Note that an ECU or the like managed by a real-time operating system such as a microcontroller is not assumed as the systems 331-1 to 331-4. This is because the management service cannot be executed unless an operating system is running.

Hereinafter, in a case where it is not necessary to individually distinguish the systems 331-1 to 331-4, they are simply referred to as the system 331.

<Specific Example of Processing of Cluster System 301>

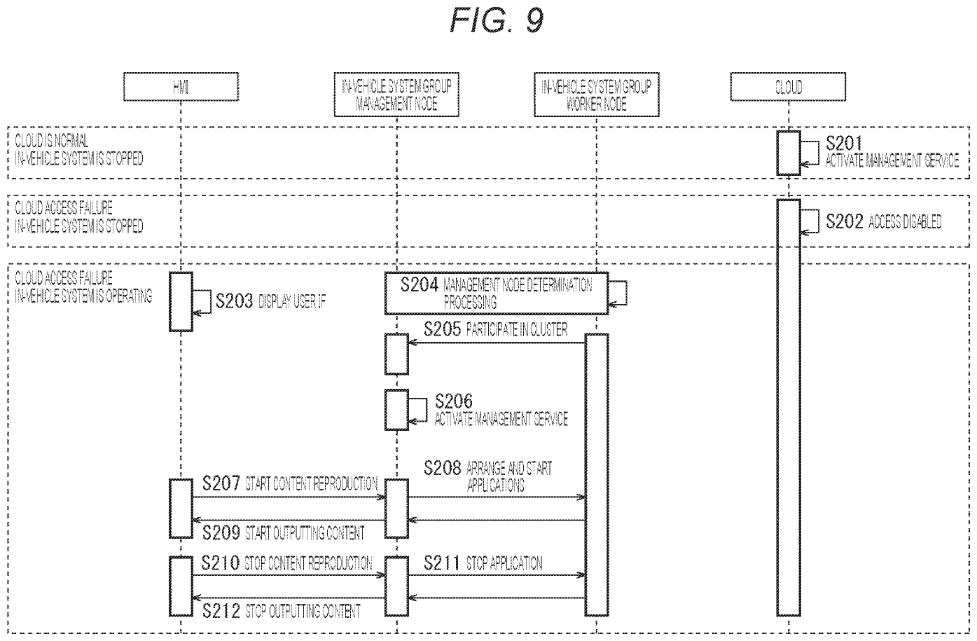

Next, a specific example of processing of the cluster system 301 will be described with reference to sequence diagrams of FIGS. 9 to 11.

### First Specific Example

First, a first specific example of processing of the cluster system 301 will be described with reference to the sequence diagram of FIG. 9.

First, the cloud 311 is operating normally, an engine of the vehicle 1 is stopped, and the in-vehicle system 312 is stopped. Then, in step S201, the system 321 of the cloud 311 becomes a management node and activates a management service.

Next, an access failure of the cloud 311 occurs. That is, access from the in-vehicle system 312 to the cloud 311 is disabled. Therefore, in step S202, access from the in-vehicle system 312 to the system 321 that is the management node is disabled.

Note that a cause of the access failure does not matter. For example, the cause of the access failure may lie on any of the cloud 311 side, the in-vehicle system 312 side, and the network side.

Next, the engine of the vehicle 1 is activated, and the in-vehicle system 312 is activated to start operation. Then, in step S203, the HMI 31 starts display of a user interface (IF).

In parallel with the processing in step S203, in step S204, management node determination processing is performed among the systems 331 of the in-vehicle system 312. As a result, one of the systems 331 becomes a management node.

In step S205, the systems 331 other than the management node among the systems 331 of the in-vehicle system 312 participate in the cluster system 301. That is, the systems 331 other than the management node request the management node to register them in the cluster system 301. In response to this, the management node registers the other systems 331 in the cluster system 301 as worker nodes. As a result, the cluster system 301 is reconstructed in the in-vehicle system 312 excluding the cloud 311.

In step S206, the management node activates the management service.

In step S207, the HMI 31 instructs the cluster system 301 to start content reproduction in response to a user operation. Here, the content is, for example, a movie, music, or the like, and includes at least one of an image or sound.

In response to this, in step S208, the cluster system 301 arranges applications and starts processing. Specifically, the management node receives the instruction to start content reproduction from the HMI 31. The management node determines arrangement of applications for realizing the content reproduction processing. Furthermore, the management node instructs each worker node to start a corresponding application and execute corresponding processing.

In response to this, each worker node activates an application instructed by the management node and starts execution of instructed processing. Furthermore, each worker node starts processing of transmitting an execution result (for example, content data or the like) of the processing to the management node as necessary.

In step S209, the in-vehicle system 312 starts outputting content. Specifically, the management node starts outputting content data to the HMI 31. The HMI 31 starts outputting content (for example, an image and sound) on the basis of the content data.

In step S210, the HMI 31 instructs the cluster system 301 to stop content reproduction in response to a user operation.

In response to this, in step S211, the cluster system 301 stops the applications. Specifically, the management node receives the instruction to stop content reproduction from the HMI 31. The management node instructs each worker node to stop the application. In response to this, each worker node stops the application.

In step S212, the in-vehicle system 312 stops outputting the content. Specifically, the management node stops outputting the content data to the HMI 31. The HMI 31 stops outputting the content.

As described above, even if an access failure occurs in the cloud 311 before the in-vehicle system 312 is activated, the cluster system 301 can be constructed only by the systems 331 of the in-vehicle system 312, and content reproduction can be executed.

### Second Specific Example

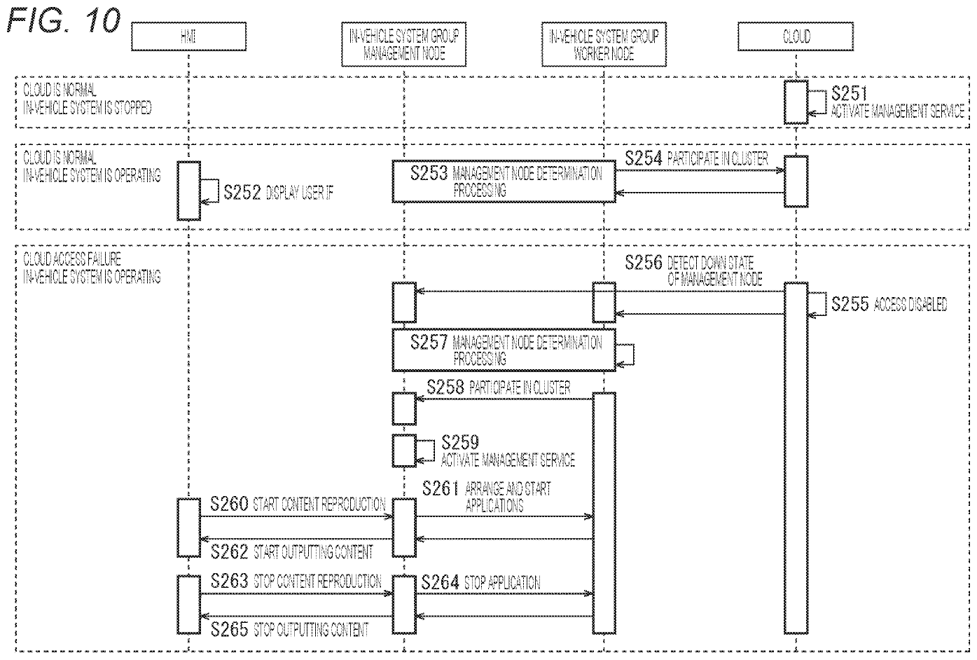

Next, a second specific example of processing of the cluster system 301 will be described with reference to the sequence diagram of FIG. 10.

First, the cloud 311 is operating normally, an engine of the vehicle 1 is stopped, and the in-vehicle system 312 is stopped. Then, in step S251, the system 321 of the cloud 311 becomes a management node and activates a management service.

Next, the engine of the vehicle 1 is activated, and the in-vehicle system 312 is activated to start operation. Then, in step S252, the HMI 31 starts display of a user IF.

In parallel with the processing in step S252, in step S253, management node determination processing is performed among the systems 331 of the in-vehicle system 312 and the system 321 of the cloud 311. Then, each system 331 recognizes the system 321 of the cloud 311 as a management node.

In step S254, the systems 331 of the in-vehicle system 312 participate in the cluster system 301. That is, each system 331 requests the system 321 of the cloud 311 that is a management node to register the system 331 in the cluster system 301. The system 321 registers each system 331 in the cluster system 301 as a worker node.

Next, an access failure of the cloud 311 occurs. Therefore, in step S255, access from the in-vehicle system 312 to the system 321 that is the management node is disabled.

In response to this, in step S256, each system 331 of the in-vehicle system 312 detects a down state of the management node.

As in the processing in step S204 of FIG. 9, in step S257, management node determination processing is performed among the systems 331 of the in-vehicle system 312. As a result, one of the systems 331 becomes a management node.

Thereafter, in steps S258 to S265, processing similar to the processing in steps S205 to S212 in FIG. 9 is performed.

As described above, even if an access failure occurs in the cloud 311 after the in-vehicle system 312 is activated and the cluster system 301 is constructed, the cluster system 301 can be reconstructed only by the systems 331 of the in-vehicle system 312, and content reproduction can be executed.

### Third Specific Example

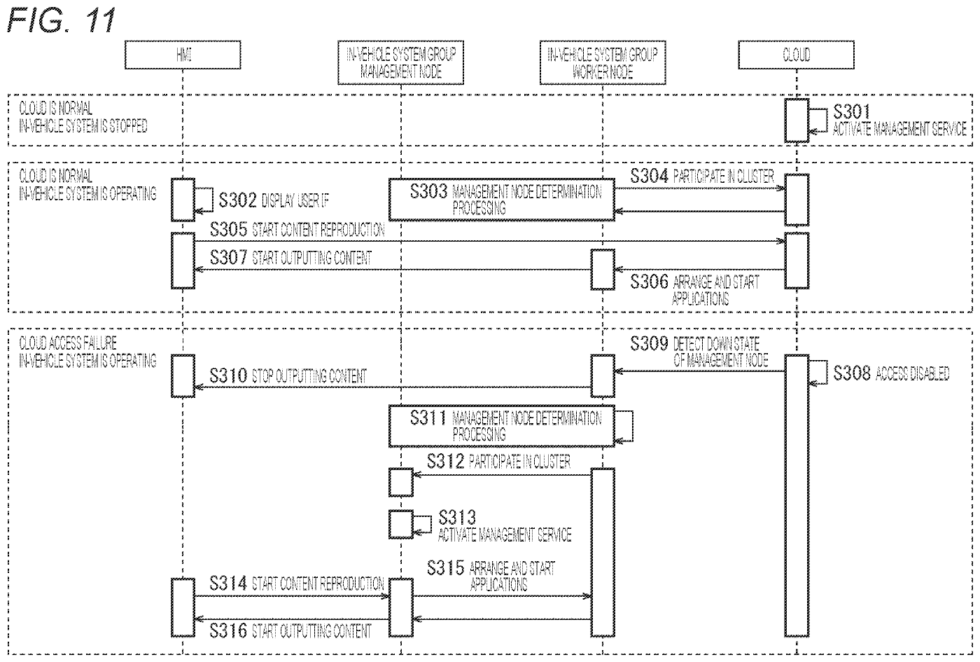

Next, a third specific example of processing of the cluster system 301 will be described with reference to the sequence diagram of FIG. 11.

First, the cloud 311 is operating normally, an engine of the vehicle 1 is stopped, and the in-vehicle system 312 is stopped. Then, in step S301, the system 321 of the cloud 311 becomes a management node and activates a management service.

Next, the engine of the vehicle 1 is activated, and the in-vehicle system 312 is activated to start operation. Then, in step S302, the HMI 31 starts display of a user IF.

In parallel with the processing in step S302, in step S303, management node determination processing is performed among the systems 331 of the in-vehicle system 312 and the system 321 of the cloud 311, as in the processing in step S253 of FIG. 10.

In step S304, each system 331 of the in-vehicle system 312 participates in the cluster system 301, as in the processing in step S254 of FIG. 10.

In step S305, the HMI 31 instructs the cluster system 301 to start content reproduction in response to a user operation.

In response to this, in step S306, the cluster system 301 arranges applications and starts processing. Specifically, the system 321 of the cloud 311 that is the management node receives the instruction to start content reproduction from the HMI 31. Furthermore, the management node (the system 321) determines arrangement of applications for realizing the content reproduction processing. Furthermore, the management node instructs each worker node to start a corresponding application and execute corresponding processing.

In response to this, each worker node (each system 331 of the in-vehicle system 312) activates an application instructed by the management node and starts execution of instructed processing.

In step S307, the in-vehicle system 312 starts outputting content. Specifically, at least one of the systems 331 of the in-vehicle system 312 that are worker nodes starts outputting content data to the HMI 31. The HMI 31 starts outputting content on the basis of the content data.

Next, an access failure of the cloud 311 occurs. Therefore, in step S308, the system 321 that is the management node becomes inaccessible.

In response to this, in step S309, the in-vehicle system 312 stops outputting the content. Specifically, the system 331 of the in-vehicle system 312 that is a worker node stops outputting content data to the HMI 31. The HMI 31 stops outputting the content.

Thereafter, in steps S311 to S316, processing similar to the processing in steps S204 to S209 in FIG. 9 is executed. As a result, the cluster system 301 is reconstructed only by the systems 331 of the in-vehicle system 312, and the reproduction of the content is continued.

As described above, even if an access failure occurs in the cloud 311 during reproduction of content, the cluster system 301 can be reconstructed only by the systems 331 of the in-vehicle system 312, and content reproduction can be continued.

<Specific Example of In-Vehicle System 312>

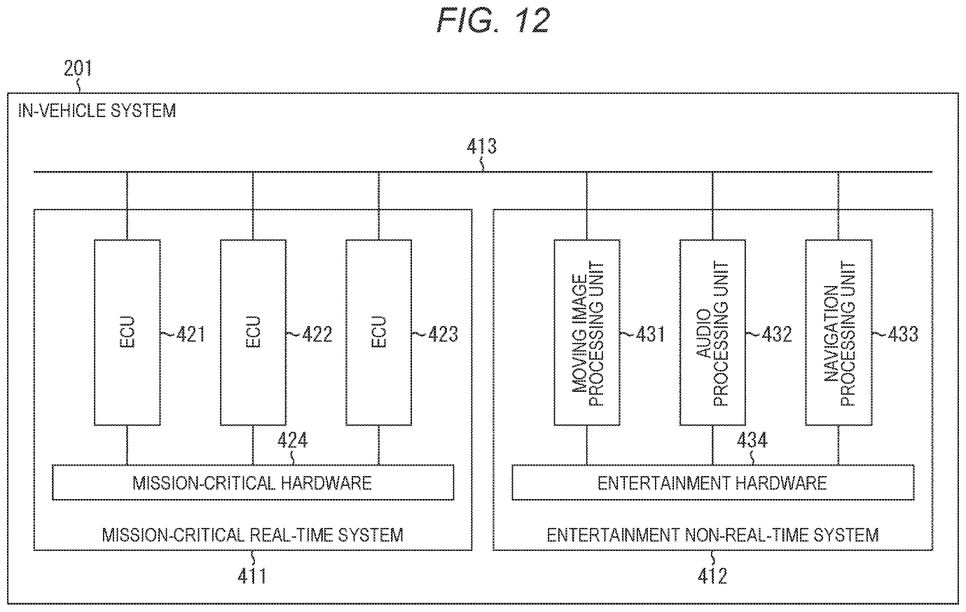

FIG. 12 illustrates a specific example of the in-vehicle system 312 of FIG. 8.

The in-vehicle system 312 includes a mission-critical real-time system 411 and an entertainment non-real-time system 412.

The mission-critical real-time system 411 is a system that is essential for traveling of the vehicle 1 and needs to execute processing in real time. The mission-critical real-time system 411 includes ECUs 421 to 423 and mission-critical hardware 424.

The ECUs 421 to 423 control the mission-critical hardware 424. Note that, although an example in which the number of ECUs is three is illustrated in FIG. 12, the number of ECUs is not particularly limited.

The mission-critical hardware 424 includes hardware that is essential for traveling of the vehicle 1 and needs to be controlled in real time, such as a steering wheel, an accelerator, and a brake.

The entertainment non-real-time system 412 is a system that realizes an entertainment application in the vehicle 1 such as moving image reproduction, music reproduction, and a navigation system. The entertainment non-real-time system 412 need not necessarily perform processing in real-time. The entertainment non-real-time system 412 includes a moving image processing unit 431, an audio processing unit 432, a navigation processing unit 433, and entertainment hardware 434.

The moving image processing unit 431 includes, for example, a processor or software, and controls the entertainment hardware 434 to perform processing such as moving image reproduction.

The audio processing unit 432 includes, for example, a processor or software, and controls the entertainment hardware 434 to perform processing such as music reproduction.

The navigation processing unit 433 includes, for example, a processor or software, and controls the entertainment hardware 434 to perform processing of a navigation system.

The entertainment hardware 434 includes, for example, hardware used for an entertainment application such as a display, a speaker, and a microphone.

The ECUs 421 to 423, the moving image processing unit 431, the audio processing unit 432, and the navigation processing unit 433 are connected to one another via an in-vehicle control network 413.

Here, for example, non-real-time systems such as the moving image processing unit 431, the audio processing unit 432, and the navigation processing unit 433 are assumed to be applied to the cluster system 301 of FIG. 8. That is, the non-real-time systems such as the moving image processing unit 431, the audio processing unit 432, and the navigation processing unit 433 constitute the cluster system 301 as the systems 331 of FIG. 8.

On the other hand, the ECUs 421 to 423 are hardly assumed to be applied to the cluster system 301. That is, the ECUs 421 to 423 need to execute mission-critical processing in real time. On the other hand, since switching or fallback operation of the systems 331 is assumed in the cluster system 301, this does not correspond to use cases of the ECUs 421 to 423.

### 4. Modifications

Hereinafter, modifications of the above-described embodiment of the present technology will be described.

<Modification Regarding Granularity of Cluster System>

For example, in an in-vehicle system, at what granularity a cluster system is constructed is important. Here, the granularity of cluster system construction is a physical size of the cluster system itself.

As described above, since a management node is always required in the cluster system, if the granularity of the cluster system is increased, influence of separation of the management node becomes very large. This is not very desirable from the viewpoint of security, stability, and the like.

Here, the following cases are assumed as the granularity of the cluster system including the in-vehicle system (the above system).
(1) in-vehicle system:cluster system=1:1
(2) in-vehicle system:cluster system=N:1
(3) in-vehicle system:cluster system=1:N
(4) in-vehicle system:cluster system=N:M

N and M are integers of 2 or more. Furthermore, in Case 4, N and M may be the same value or may be different values.

Case 1 is a case where one cluster system is constructed by one in-vehicle system. That is, Case 1 is a case where a system on one in-vehicle system belongs to one cluster system. Usually, it is assumed that Case 1 is applied to construction of a cluster system. The example of FIG. 8 described above corresponds to Case 1.

Case 2 is a case where one cluster system is constructed by a plurality of in-vehicle systems. That is, Case 2 is a case where systems on a plurality of in-vehicle systems belong to one cluster system. For example, it is assumed that Case 2 is applied in a case where it is desired to control a plurality of vehicles as a group in an application, such as entertainment or a race, different from a consumer application.

Case 3 is a case where a plurality of cluster systems is constructed by one in-vehicle system. That is, Case 3 is a case where a system on one in-vehicle system belongs to a plurality of cluster systems.

Case 4 is a case where a plurality of cluster systems is constructed by a plurality of in-vehicle systems. That is, Case 4 is a case where systems on a plurality of in-vehicle systems belong to a plurality of cluster systems.

The present technology can be applied to any of Cases 1 to 4. However, Case 1 is desirable from the viewpoint of stability and security.

<Other Modifications>

For example, it is possible to simultaneously construct a plurality of cluster systems by using a namespace in a same network system (for example, the network system including the cloud 311, the in-vehicle system 312, and the network 313 in FIG. 8). Note that, for example, the same system can belong to a plurality of cluster systems (namespaces).

For example, application management may be performed by a system other than a management system. For example, the management system may manage a cluster system, and one of worker nodes may manage an application.

A moving body to which the present technology can be applied is not limited to a vehicle. That is, the present technology can also be applied to a cluster system including a system including a moving body other than a vehicle or a system operating on the moving body. As such a moving body, for example, a robot, a drone, a two-wheeled vehicle, a train, a ship, an airplane, or the like is assumed.

The present technology can also be applied to, for example, a cluster system including an edge device other than a moving body or a system operating on the edge device. As such an edge device, for example, a smartphone, a tablet terminal, a personal computer, or the like is assumed.

The present technology can also be applied to, for example, a cluster system including a plurality of types of edge devices or a plurality of systems each operating on the plurality of types of edge devices.

The present technology can also be applied to, for example, a cluster system including only an edge device or only a system operating only on the edge device.

### 5. Others

<Computer Configuration Example>

The above-described series of processing can be executed by hardware or software. In a case where the series of processing is executed by software, a program constituting the software is installed in a computer. Here, the computer includes a computer incorporated in dedicated hardware, a general-purpose personal computer capable of executing various functions by installing various programs, and the like, for example.

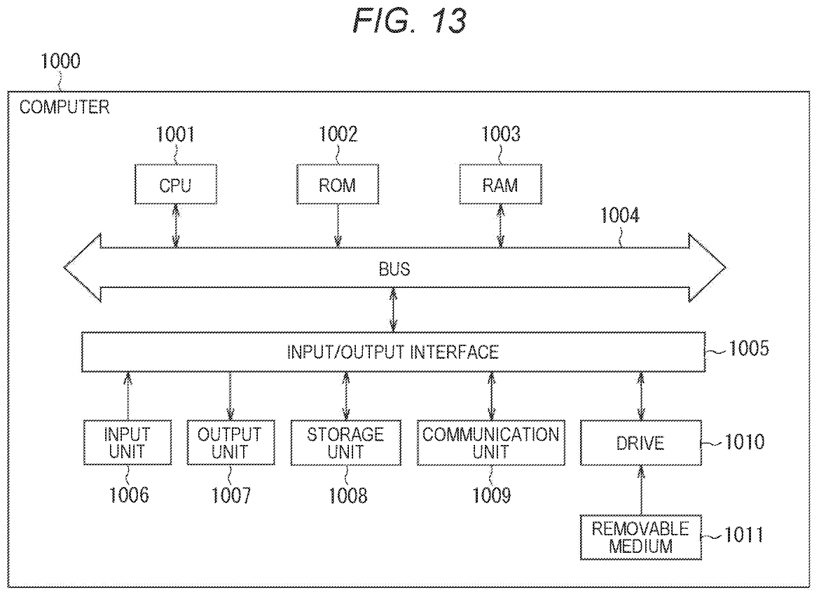

FIG. 13 is a block diagram illustrating a configuration example of hardware of a computer that executes the above-described series of processing by a program.

In a computer 1000, a central processing unit (CPU) 1001, a read only memory (ROM) 1002, and a random access memory (RAM) 1003 are mutually connected by a bus 1004.

An input/output interface 1005 is further connected to the bus 1004. An input unit 1006, an output unit 1007, a recording unit 1008, a communication unit 1009, and a drive 1010 are connected to the input/output interface 1005.

The input unit 1006 includes an input switch, a button, a microphone, an imaging element, and the like. The output unit 1007 includes a display, a speaker, and the like. The recording unit 1008 includes a hard disk, a nonvolatile memory, and the like. The communication unit 1009 includes a network interface and the like. The drive 1010 drives a removable medium 1011 such as a magnetic disk, an optical disk, a magneto-optical disk, or a semiconductor memory.

In the computer 1000 configured as described above, for example, the CPU 1001 loads a program recorded in the recording unit 1008 into the RAM 1003 via the input/output interface 1005 and the bus 1004 and executes the program, whereby the above-described series of processing is performed.

The program executed by the computer 1000 (CPU 1001) can be provided by being recorded in the removable medium 1011 as a package medium or the like, for example. Furthermore, the program can be provided via a wired or wireless transmission medium such as a local area network, the Internet, or digital satellite broadcasting.

In the computer 1000, the program can be installed in the recording unit 1008 via the input/output interface 1005 by attaching the removable medium 1011 to the drive 1010. Furthermore, the program can be received by the communication unit 1009 via a wired or wireless transmission medium and installed in the recording unit 1008. In addition, the program can be installed in the ROM 1002 or the recording unit 1008 in advance.

Note that the program executed by the computer may be a program for processing in time series in the order described in the present description, or a program for processing in parallel or at a necessary timing such as when a call is made.

Furthermore, in the present description, a system means a set of a plurality of components (devices, modules (parts), and the like), and it does not matter whether or not all components are in the same housing. Therefore, both of a plurality of devices housed in separate housings and connected via a network and a single device in which a plurality of modules is housed in one housing are systems.

Moreover, the embodiment of the present technology is not limited to the above-described embodiment, and various modifications can be made without departing from the gist of the present technology.

For example, the present technology can employ a configuration of cloud computing in which one function is shared by a plurality of devices via a network and processed jointly.

Furthermore, each step described in the above-described flowcharts can be executed by one device, or can be executed in a shared manner by a plurality of devices.

Moreover, in a case where a plurality of processes is included in one step, the plurality of processes included in the one step can be executed in a shared manner by a plurality of devices in addition to being executed by one device.

<Examples of Configuration Combinations>

The present technology can also have the following configurations.
(1)
An information processing system that operates in a moving body, is connected to other information processing system(s) via a network, and constitutes a cluster system with the other information processing system(s), the information processing system including:
a management node determination unit that executes management node determination processing of determining a management node that manages the cluster system in cooperation with the other information processing system(s);
a management node processing unit that executes processing of the management node in a case where the information processing system becomes the management node by the management node determination processing; and
a worker node processing unit that executes processing of a worker node other than the management node in a case where the information processing system becomes the worker node by the management node determination processing.
(2)
The information processing system according to (1), in which
the worker node processing unit monitors a state of the management node, and
in a case where the worker node processing unit or another worker node determines that the management node is not present, the management node determination unit executes the management node determination processing in cooperation with other worker nodes to determine a new management node.
(3)
The information processing system according to (2), in which
the management node determination unit reconstructs the cluster system in a case where the information processing system becomes the new management node.
(4)
The information processing system according to (2) or (3), in which
the worker node processing unit requests the new management node to register the information processing system in the cluster system in a case where another worker node becomes the new management node.
(5)
The information processing system according to any one of (2) to (4), in which
the management node processing unit regularly notifies the worker node of presence of the management node.
(6)
The information processing system according to any one of (1) to (5), in which
the management node determination unit determines the management node on the basis of a priority set in advance.
(7)
The information processing system according to (6), in which
the priority is set on the basis of at least one of capabilities, processing contents, intended uses, or operating environments of the information processing system and the other information processing system(s).
(8)
The information processing system according to any one of (1) to (7), in which
the management node determination unit determines the management node from among candidates for the management node by a majority decision of the information processing system and the other information processing system(s).
(9)
The information processing system according to any one of (1) to (8), in which
the management node processing unit constructs and updates the cluster system.
(10)
The information processing system according to (9), in which
the worker node processing unit requests the management node to register the information processing system in the cluster system.
(11)
The information processing system according to (9) or (10), in which
the management node processing unit further allocates a role to the worker node and instructs the worker node to execute processing.
(12)
The information processing system according to (11), in which
the management node processing unit determines an application to be executed by each worker node, and instructs each worker node to execute processing of the application to be executed by the worker node.
(13)
The information processing system according to (11) or (12), in which
the worker node processing unit executes processing in accordance with an instruction from the management node.
(14)
The information processing system according to any one of (1) to (13), in which
at least one of the other information processing system(s) exists outside the moving body.
(15)
The information processing system according to (14), in which
the at least one of the other information processing system(s) is present on a cloud.
(16)
An information processing method including causing an information processing system that operates in a moving body, is connected to other information processing system(s) via a network, and constitutes a cluster system with the other information processing system(s) to:
execute management node determination processing of determining a management node that manages the cluster system in cooperation with the other information processing system(s);
execute processing of the management node in a case where the information processing system becomes the management node by the management node determination processing; and
execute processing of a worker node other than the management node in a case where the information processing system becomes the worker node by the management node determination processing.
(17)
A program for causing a computer that operates in a moving body, is connected to other information processing system(s) via a network, and constitutes a cluster system with the other information processing system(s) to:
execute management node determination processing of determining a management node that manages the cluster system in cooperation with the other information processing system(s);
execute processing of the management node in a case where the computer becomes the management node by the management node determination processing; and
execute processing of a worker node other than the management node in a case where the computer becomes the worker node by the management node determination processing.
(18)
A cluster system including a plurality of information processing systems, in which
at least one of the information processing systems operates in a moving body,
the plurality of the information processing systems executes management node determination processing of determining a management node that manages the cluster system in cooperation with one another, and
an information processing system that has become the management node by the management node determination processing constructs the cluster system in which other information processing system(s) serve(s) as a worker node(s).
(19)
The cluster system according to (18), in which the worker node(s) monitor(s) a state of the management node,
in a case where at least one of the worker node(s) determines that the management node is not present, the plurality of the worker nodes executes the management node determination processing in cooperation with one another to determine a new management node, and
an information processing system that has become the new management node by the management node determination processing reconstructs the cluster system in which other information processing system(s) serve(s) as the worker node(s).

Note that the effects described in the present specification are merely examples and are not limited, and other effects may be provided.

### REFERENCE SIGNS LIST

1 Vehicle
11 Vehicle control system
21 Vehicle control ECU
31 HMI
201 Cluster system
211-1 to 211-n System
212 Management service
221-1 to 221-n Management node determination unit
222-1 to 222-n Management node processing unit
223-1 to 223-n Worker node processing unit
224-1 to 224-n Control unit
231-1 to 231-n Cluster management unit
232-1 to 232-n Application management unit
301 Cluster system
311 Cloud
312 In-vehicle system
321, 331-1 to 331-4 System

1. An information processing system that operates in a moving body, is connected to other information processing system(s) via a network, and constitutes a cluster system with the other information processing system(s), the information processing system comprising:
a management node determination unit that executes management node determination processing of determining a management node that manages the cluster system in cooperation with the other information processing system(s);
a management node processing unit that executes processing of the management node in a case where the information processing system becomes the management node by the management node determination processing; and
a worker node processing unit that executes processing of a worker node other than the management node in a case where the information processing system becomes the worker node by the management node determination processing.

2. The information processing system according to claim 1, wherein
the worker node processing unit monitors a state of the management node, and
in a case where the worker node processing unit or another worker node determines that the management node is not present, the management node determination unit executes the management node determination processing in cooperation with other worker nodes to determine a new management node.

3. The information processing system according to claim 2, wherein
the management node determination unit reconstructs the cluster system in a case where the information processing system becomes the new management node.

4. The information processing system according to claim 2, wherein
the worker node processing unit requests the new management node to register the information processing system in the cluster system in a case where another worker node becomes the new management node.

5. The information processing system according to claim 2, wherein
the management node processing unit regularly notifies the worker node of presence of the management node.

6. The information processing system according to claim 1, wherein
the management node determination unit determines the management node on a basis of a priority set in advance.

7. The information processing system according to claim 6, wherein
the priority is set on a basis of at least one of capabilities, processing contents, intended uses, or operating environments of the information processing system and the other information processing system(s).

8. The information processing system according to claim 1, wherein
the management node determination unit determines the management node from among candidates for the management node by a majority decision of the information processing system and the other information processing system(s).

9. The information processing system according to claim 1, wherein
the management node processing unit constructs and updates the cluster system.

10. The information processing system according to claim 9, wherein
the worker node processing unit requests the management node to register the information processing system in the cluster system.

11. The information processing system according to claim 9, wherein
the management node processing unit further allocates a role to the worker node and instructs the worker node to execute processing.

12. The information processing system according to claim 11, wherein
the management node processing unit determines an application to be executed by each worker node, and instructs each worker node to execute processing of the application to be executed by the worker node.

13. The information processing system according to claim 11, wherein
the worker node processing unit executes processing in accordance with an instruction from the management node.

14. The information processing system according to claim 1, wherein
at least one of the other information processing system(s) exists outside the moving body.

15. The information processing system according to claim 14, wherein
the at least one of the other information processing system(s) is present on a cloud.

16. An information processing method comprising causing an information processing system that operates in a moving body, is connected to other information processing system(s) via a network, and constitutes a cluster system with the other information processing system(s) to:
execute management node determination processing of determining a management node that manages the cluster system in cooperation with the other information processing system(s);
execute processing of the management node in a case where the information processing system becomes the management node by the management node determination processing; and
execute processing of a worker node other than the management node in a case where the information processing system becomes the worker node by the management node determination processing.

17. A program for causing a computer that operates in a moving body, is connected to other information processing system(s) via a network, and constitutes a cluster system with the other information processing system(s) to:
execute management node determination processing of determining a management node that manages the cluster system in cooperation with the other information processing system(s);
execute processing of the management node in a case where the computer becomes the management node by the management node determination processing; and
execute processing of a worker node other than the management node in a case where the computer becomes the worker node by the management node determination processing.

18. A cluster system comprising a plurality of information processing systems, wherein
at least one of the information processing systems operates in a moving body,
the plurality of the information processing systems executes management node determination processing of determining a management node that manages the cluster system in cooperation with one another, and
an information processing system that has become the management node by the management node determination processing constructs the cluster system in which other information processing system(s) serve(s) as worker node(s).

19. The cluster system according to claim 18, wherein
the worker node(s) monitor(s) a state of the management node,
in a case where at least one of the worker node(s) determines that the management node is not present, the plurality of the worker nodes executes the management node determination processing in cooperation with one another to determine a new management node, and
an information processing system that has become the new management node by the management node determination processing reconstructs the cluster system in which other information processing system(s) serve(s) as the worker node(s).
